(19) United States
(12) Patent Application Publication
(10) Pub. No.: US 2003/0090573 A1
(43) Pub. Date: May 15, 2003

(54) Camera with printer, communication apparatus, control method thereof, control program, and storage medium

(76) Inventor: Akihiko Tojo, Kanagawa (JP)

Correspondence Address: MORGAN & FINNEGAN, L.L.P., 345 Park Avenue, New York, NY, 10154-0053, US

(21) Appl. No.: 10/307,875

(22) Filed: Dec. 2, 2002

Related U.S. Application Data
(63) Continuation of application No. PCT/JP02/08960, filed on Sep. 4, 2002.

(30) Foreign Application Priority Data
Sep. 6, 2001 (JP) 270221/2001

(51) Int. Cl. H04N 5/225

(52) U.S. Cl. 348/207.2; 348/372

(57) ABSTRACT

A camera that has a printer, an a communication unit, a photoflash unit, and a booster for supplying a power to the photoflash unit, can control boost operation of booster while communication is being executed.

### TECHNICAL FIELD

The present invention relates to a camera with a printer, which has a photoflash unit and printer, a communication apparatus having an image sensing means and illumination means, a control method thereof, a control program, and a storage medium.

### BACKGROUND ART

Conventionally, cameras with printers are known, which are designed to store in a memory image information sensed by an electronic image sensing means such as a solid-state image sensing element and arbitrarily printing the image information.

As printers used for such cameras, generally, a waxy thermal transfer printer, dye-sublimation thermal transfer printer, and ink-jet printer are available. Especially, the ink-jet printer is excellent in terms of running cost, size, power consumption, and output speed. The ink-jet printer can appropriately be used for, especially, a camera integrated with a printer, which requires portability.

Cameras with printers include a camera integrated with a printer and a camera which bi-directionally communicates with a separate printer through a wire or wireless communication path. In the following description, a camera with a printer includes both types.

However, the conventional cameras with printers are not satisfactory at all in operability, size, and cost. Especially, requirements for operability and size are more strict in a camera integrated with a printer because it requires portability.

For example, a camera with a printer in which a camera and an ink-jet printer are integrated is designed to execute recovery operation to ensure the ink supply system by sucking residual ink in the ink supply path using a pump if the printer has not been used for a long time, thereby preventing any clogging with ink and discharge errors. This recovery operation takes several to several ten sec. For this reason, power consumption by this operation is high for a battery. In addition, a power supply circuit for supplying power for this recovery operation and a power supply circuit for printing by the printer are prepared independently of the camera side. It is therefore difficult to reduce the size and weight of the apparatus.

Furthermore, in a camera having a communication function, e.g., a portable telephone with a camera, the battery power is limited. Hence, speech communication may be interrupted or disabled by boost operation for a flash (light source) serving as an illumination means or a printer. Especially, in terminating operation, since a large current flows to the communication circuit, the power supply may temporarily drop to cause hang-up of the circuit. In addition, noise generated by oscillation operation for boosting inside the driving circuit for the flash or printer may enter as crosstalk.

### DISCLOSURE OF INVENTION

The present invention has been made to solve the above problem, and has as its object to provide a camera that has a printer, an a communication unit, a photoflash unit, and a booster for supplying a power to the photoflash unit, can control boost operation of booster while communication is being executed.

Other features and advantages of the present invention will be apparent from the following description taken in conjunction with the accompanying drawings, in which like reference characters designate the same or similar parts throughout the figures thereof.

### BRIEF DESCRIPTION OF DRAWINGS

The invention will be better understood and its numerous objects and advantages will become more apparent to those skilled in the art by reference to the following drawings, in conjunction with the accompanying specification, in which:

FIG. 1 is a front view of a camera with a printer to which the present invention can be applied;

FIG. 2 is a perspective view of the camera shown in FIG. 1 when viewed obliquely from the front;

FIG. 3 is a perspective view of the camera shown in FIG. 1 when viewed obliquely from behind;

FIG. 4 is a perspective view of a media pack attachable to the camera shown in FIG. 1;

FIG. 5 is a perspective view showing the layout relationship between main components in the camera shown in FIG. 1;

FIG. 6 is a perspective view of a print unit in FIG. 5;

-FIG. 7 is a perspective view of the print unit shown in FIG. 6 whose some parts are removed;

FIG. 8 is a perspective view of a carriage in the print unit shown in FIG. 6;

FIG. 9 is a perspective view of the components of a print media convey system in the print unit shown in FIG. 6;

FIG. 10 is a block diagram showing the schematic arrangement of a camera unit A100 and print unit B100;

FIG. 11 is a functional block diagram of image signal processing in the camera unit A100;

FIG. 12 is a functional block diagram of image signal processing in the print unit B100;

FIG. 13 is a functional block diagram of anti-vibration control in a photographing mode in the camera unit and carriage control in a printer mode;

FIG. 14 is a functional block diagram of power supply control in which a DC/DC converter 150 for causing the photoflash unit to emit light is used as a printing or pumping boost power supply of a print head 207 of the print unit B100;

FIG. 15 is an output timing chart of drive signals S1 to S4 in the power supply control shown in FIG. 14;

FIG. 16 is a flow chart showing the operation procedure of the camera with a printer;

FIG. 17 is a flow chart showing the operation procedure of the camera with a printer;

FIG. 18 is a flow chart showing the operation procedure of the camera with a printer;

FIG. 19 is a flow chart showing the operation procedure of the camera with a printer;

FIG. 20 is a flow chart showing the expendable replenishment (fill-up) procedure of a media pack C100;

FIG. 21 is a flow chart of incoming call/communication detection operation; and

FIG. 22 is a flow chart showing the operation procedure of a camera with a printer according to other embodiment of the present invention.

### BEST MODE FOR CARRYING OUT THE INVENTION

Preferred embodiments of the present invention will be described in detail in accordance with the accompanying drawings.

In this specification, “print” (to be sometimes referred to as “printing”) means not only formation of significant information such as a character or graphic pattern but also formation of an image, design, or pattern on print media in a broader sense regardless of whether the information is significant or insignificant or has become obvious to allow human visual perception.

“Print” also means processing of print media.

“Print media” mean not only paper sheets used in a general printer but also any media capable of receiving ink, including fabrics, plastic films, metal plates, and glass, ceramic, wood, and leather materials in a broader sense.

“Ink” (to be sometimes referred to as a “liquid”) should also be interpreted in a broader sense, like definition of “print”, and means a liquid which is supplied onto print media to form an image, design, pattern, or the like, process print media, or process ink (e.g., coagulate or insolubilize color materials in ink).

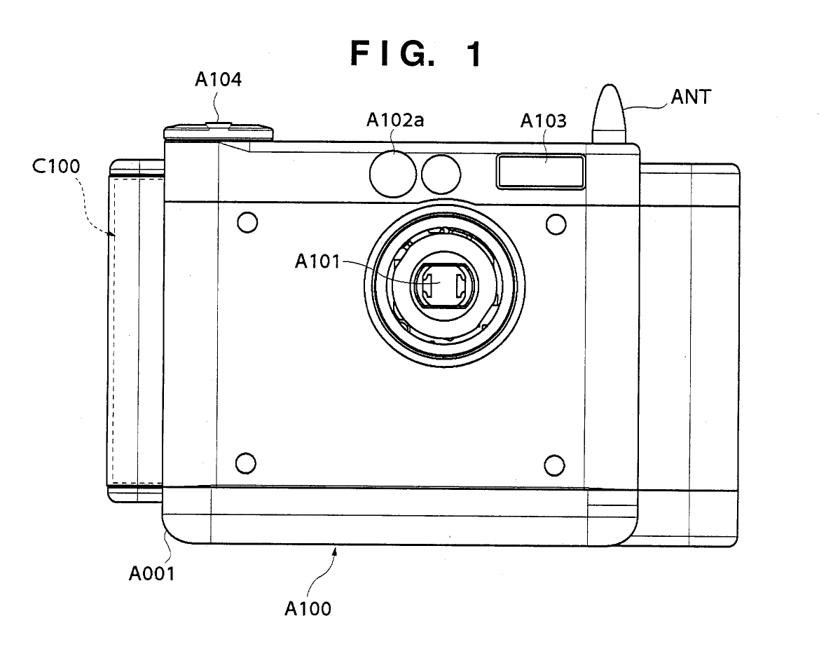

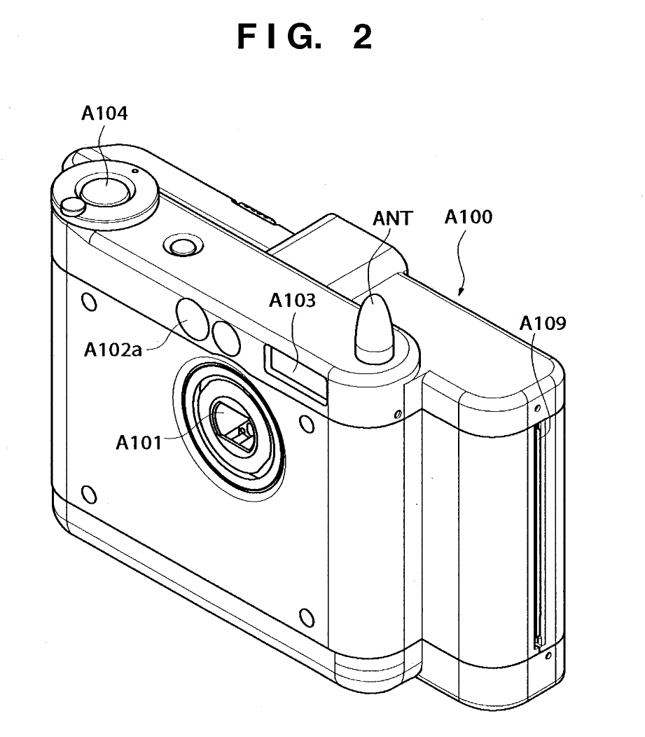

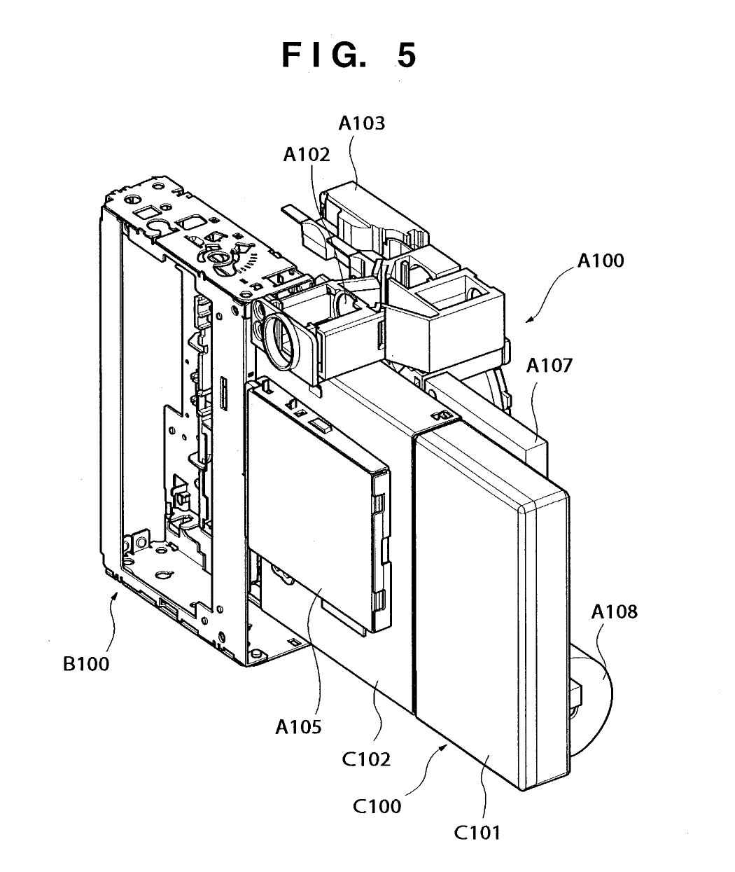

The basic mechanical arrangement of this apparatus will be described first with reference to FIGS. 1 to 9. This apparatus is designed as a camera with a printer. In a body A001, a print unit (printing apparatus unit) B100 is integrally incorporated on the rear side of a camera unit A100. Note that the camera unit A100 and print unit B100 may be detachable from each other. In this case, the units are designed to directly connect bi-directional communication contacts prepared on the respective sides when attached. The print unit B100 prints an image using inks and print media supplied from a media pack C100. In this arrangement, as is apparent from FIG. 5 in which the body A001 without its outer case is viewed from behind, the media pack C100 is inserted to the right side of the body A001 in FIG. 5, and the print unit B100 is arranged on the left side of the body A001 in FIG. 5. When printing is to be executed by the print unit B100, the body A001 can be set with its LCD (Liquid Crystal Display) display unit A105 on the upper side and a lens A101 on the lower side. In this printing posture, a print head B120 (to be described later) in the print unit B100 discharges inks downward. The printing posture is not limited to this posture and may be the same as the posture in a photographing state by the camera unit A100. However, the printing posture to discharge inks downward is preferable from the viewpoint of stable print operation.

Next, the basic mechanical arrangement of this apparatus will be described in association with each of A “camera unit”, B “media pack”, and C “print unit”.

A “Camera Unit”

The camera unit A100 basically constructs a general digital camera. The camera unit A100 constructs a digital camera which incorporates a printer and is integrated with the body A001 together with the print unit B100 (to be described later) to have an outer appearance as shown in FIGS. 1 to 3. Referring to FIGS. 1 to 3, reference numeral A101 denotes the lens; A102, an optical viewfinder; A102a, a finder window; A103, a photoflash unit; A104, a release button; A105, the LCD (Liquid Crystal Display) display unit (external display unit); ANT, an antenna; TKY, telephone number input keys; 102, a microphone; and 113, a loudspeaker. The camera unit A100 executes processing of data sensed using an image sensing element such as a CCD (Charge Coupled Device) or MOS sensor, storage of an image in a compact flash (registered trademark) memory card (e.g., a CF card (Compact Flash card)) A107, signal processing for image display, and exchange (bi-directional communication) of various kinds of data with the print unit B100. When a photographed image is printed on a print media C104 (to be described later), the print media C104 on which the image is printed are discharged to a discharge unit A109 having a cover (not shown). Reference numeral A108 in FIG. 5 denotes a battery serving as a power supply of the camera unit A100 and print unit B100.

In this embodiment, the camera unit A100 has a radio communication (telephone) function such that audio and/or image communication with an external device is possible.

B “Media Pack”

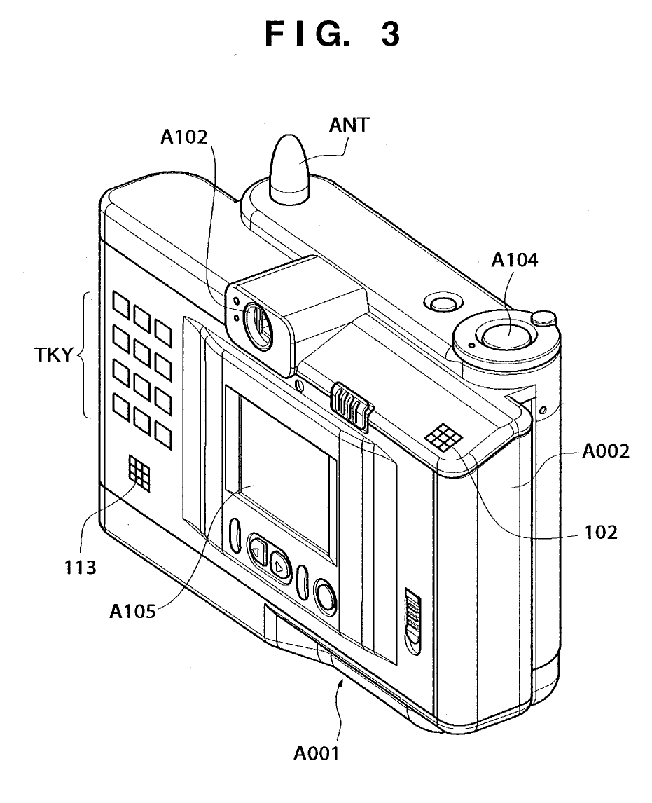

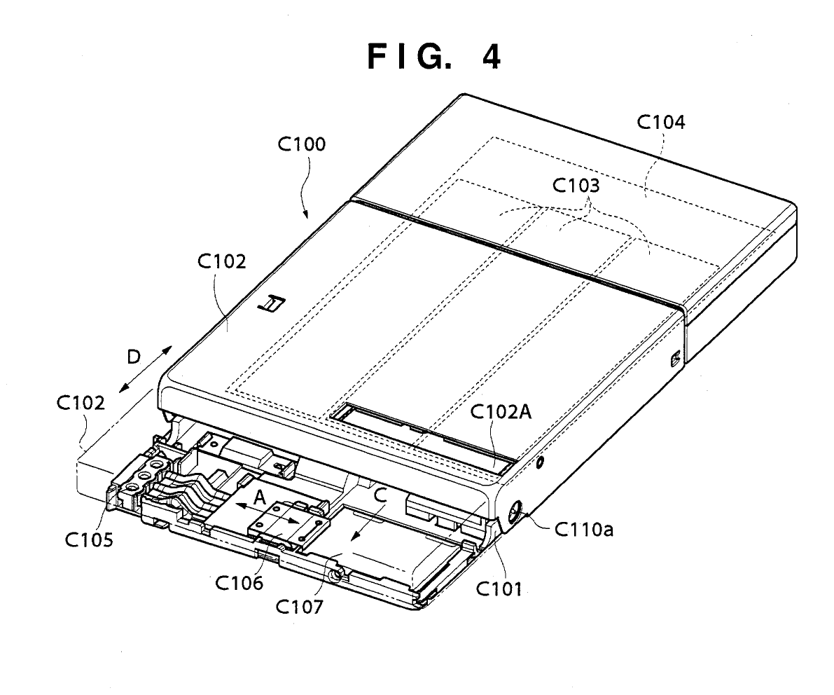

The media pack C100 can be detached from the body A001. In this example, the cover (not shown) of the body A001 is opened, and the media pack C100 is inserted for an insertion part A002 (FIG. 3) and thus attached to the body A100, as shown in FIG. 1. When the media pack C100 is not attached, the insertion part A002 is closed by the cover, as shown in FIG. 3. The insertion part A002 is opened when the media pack is to be attached. FIG. 5 shows a state wherein the outer case is detached from the body A001 having the media pack C100. A pack body C101 of the media pack C100 has a shutter C102 that is slidable in the direction of an arrow D, as shown in FIG. 4. When the media pack C100 is not attached to the body A001, the shutter C102 is slidably located at a position indicated by an alternate long and two-dashed line in FIG. 4 while being biased by a spring (not shown). When the media pack C100 is attached to the body A001, the shutter C102 slides to a position indicated by a solid line in FIG. 4 against the biasing force of the spring.

The pack body C101 stores ink packs C103 and print media C104. Referring to FIG. 4, the ink packs C103 are stored under the print media C104. In this example, three ink packs C103 are prepared to individually store Y (yellow), M (magenta), and C (cyan) inks. The print media C104 stored here comprise about 20 pieces of media. A combination of inks and print media C104 optimum for image printing is selected and stored in the single media pack C100. Hence, when various kinds of media packs C100 (e.g., media packs for an ultrahigh image quality, normal image quality, seal (separated seal), gloss paper, recycled paper, and neutral paper) with different combinations of inks and print media are prepared, and one of them is selectively attached to the body A001 in accordance with the type of image to be printed and the application purpose of the print media on which images are formed, images according to the purpose can be reliably printed using an optimum combination of inks and print media. In addition, the media pack C100 has a nonvolatile memory, e.g., an EEPROM (identification IC) serving as a memory (to be described later). The EEPROM stores the types and residual amounts of inks and print media stored in the media pack, fill-up or manufacturing date/time information of the inks and print media, log data such as error contents data in case of abnormality and its date/time information, and data of changes over time of, e.g., the color characteristics of the inks and print media, as will be described later.

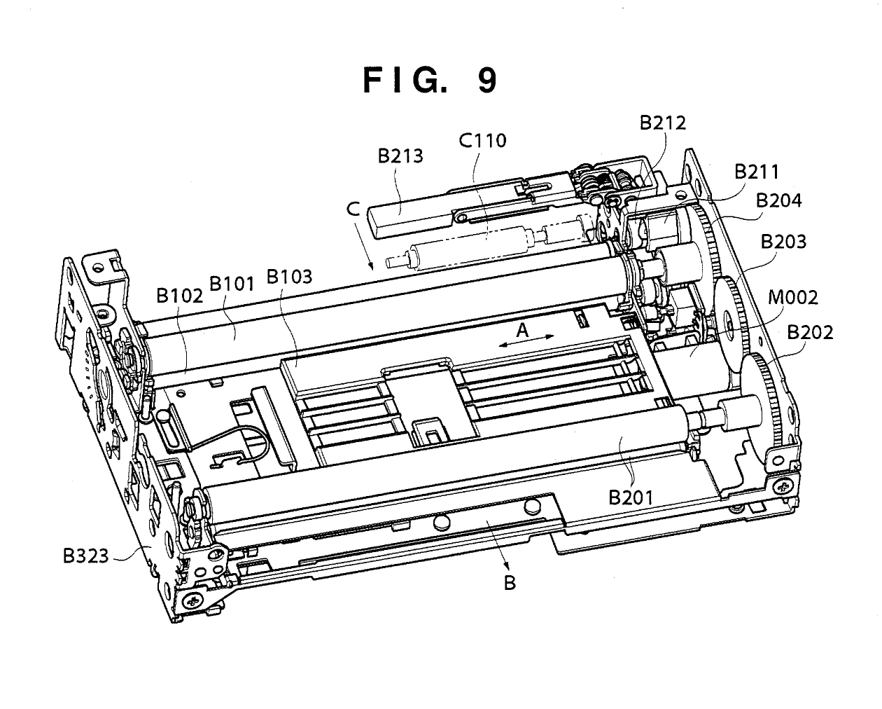

The ink packs C103 are connected to the ink supply system (to be described later) on the body A001 side through three joints C105 corresponding to the Y, M, and C inks when the media pack C100 is attached to the body A001. On the other hand, the print media C104 are picked up by a paper feed roller C110 (FIG. 9) (to be described later), separated one by one by a separation mechanism (not shown), and fed in a direction indicated by an arrow C. The driving force for the paper feed roller C110 is supplied, through a connection part C110a, from a convey motor M002 (FIG. 9) (to be described later) arranged on the body A001 side.

The pack body C101 also has a wiper C106 for wiping the print head (to be described later) of the print unit for cleaning, and an ink absorber C107 for absorbing wasted inks discharged from a liquid waste joint (not shown) on the print unit side. The print head of the print unit reciprocally moves in the main scanning direction indicated by an arrow A, as will be described later. When the media pack C100 is detached from the body A001, the shutter C102 slides to the position indicated by the alternate long and two-dashed line in FIG. 4 upon being biased by the spring (not shown), thereby protecting the joint C105, wiper C106, and ink absorber C107.

C “Print Unit”

The print unit B100 of this example is a serial type print unit using an ink-jet print head. The print unit B100 will be described for each of C-1 “print operation unit”, C-2 “print media convey system”, and C-3 “ink supply system”.

C-1 “Print Operation Unit”

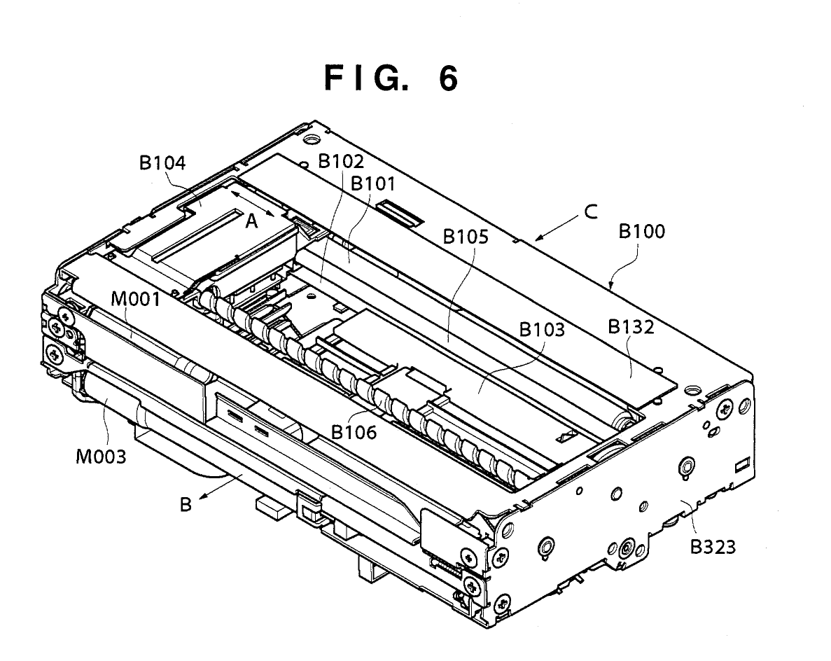

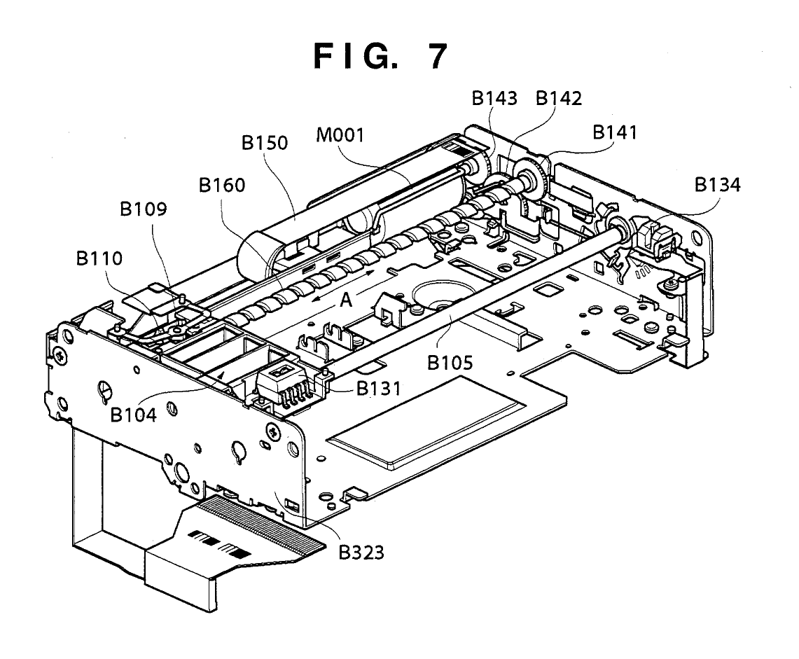

FIG. 6 is a perspective view of the entire print unit B100. FIG. 7 is a perspective view of the print unit B100 whose some parts are removed.

As shown in FIG. 5, the distal end of the media pack C100 attached to the body A001 is located at a predetermined position in the body of the print unit B100. The print media C104 fed for the media pack C100 in the direction indicated by the arrow C in FIG. 6 are conveyed on a platen B103 in the sub-scanning direction (direction perpendicular to the main scanning direction A) indicated by an arrow B while being sandwiched between an LF roller B101 and an LF pinch roller B102 in the print media convey system (to be described later). Reference numeral B104 denotes a carriage that is reciprocally moved in the main scanning direction indicated by the arrow A along a guide shaft B105 and lead screw B106.

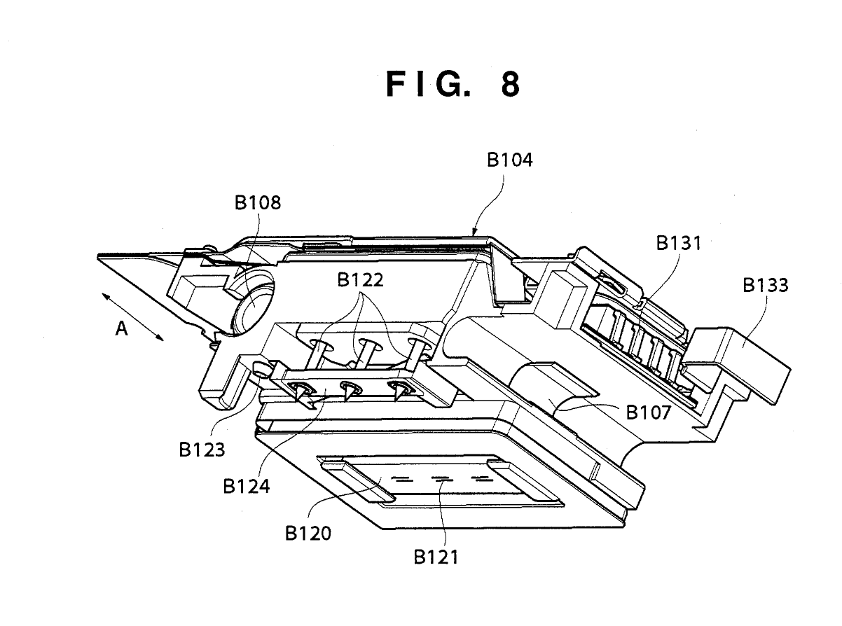

As shown in FIG. 8, the carriage B104 has a bearing B107 for the guide shaft B105 and a bearing B108 for the lead screw B106. A screw pin B109 (FIG. 7) that projects to the inside of the bearing B108 is attached to a predetermined position of the carriage B104 by a spring B110. When the distal end of the screw pin B109 engages with a spiral groove formed in the outer periphery of the lead screw B106, the rotation of the screw pin B109 is converted into reciprocal movement of the carriage B104 in the direction of arrow A.

An ink-jet print head B120 capable of discharging Y, M, and C inks and a sub tank (not shown) for storing inks to be supplied to the print head B120 are mounted on the carriage B104 in FIG. 8. A plurality of ink discharge openings B121 (FIG. 8) arrayed in a direction crossing (in this example, a direction perpendicular to) the main scanning direction of arrow A are formed in the print head B120. Each ink discharge opening B121 constitutes a nozzle capable of discharging an ink supplied from the sub tank. As a means for generating an energy for ink discharge, an electrothermal transducer prepared for each nozzle can be used. The electrothermal transducer is driven to generate heat so as to generate bubbles in the ink in the nozzle. By the bubble energy, ink droplets are discharged from the ink discharge opening B121.

The sub tank has a smaller capacity than that of the ink packs C103 stored in the media pack C100. The sub tank has a size to store the respective color inks in amounts necessary for image printing on at last one of the print media C104. In the sub tank, ink supply parts and negative pressure introduction parts are formed at the ink storage parts for the Y, M, and C inks. The ink supply parts are individually connected to three corresponding hollow needles B122. The negative pressure introduction parts are connected to a common supply air port B123. When the carriage B104 moves to the home position shown in FIG. 6, as will be described later, the inks are supplied from the ink packs C103 of the media pack C100 to the sub tank in a manner to be described later.

In the carriage B104 shown in FIG. 8, when the needles B122 are not connected to the joints C105 on the media pack side, a needle cover B124 moves to a position to protect the needles B122. When the needles B122 are connected to the joints C105, the needle cover B124 is pressed upward in FIG. 8 against the force of a spring to cancel protection of the needles B122. The A-direction movement position of the carriage B104 is detected by an encoder sensor B131 on the carriage B104 side and a linear scale B132 (FIG. 6) on the body side of the print unit B100. That the carriage B104 has moved to the home position is detected by an HP (Home Position) flag B133 on the carriage B104 side and an HP sensor (Home Position Sensor) B134 (FIG. 7) on the body side of the print unit B100.

Referring to FIG. 7, support shafts (not shown) are arranged at two ends of the guide shaft B105 at positions decentered from its central axis. When the guide shaft B105 is pivotally adjusted about the support shafts, the position of the carriage B104 is adjusted so that the distance (to be also referred to as a “paper distance”) between the print head B120 and the print media C104 on the platen B103 is adjusted. The lead screw B106 is rotated by a carriage motor M001 through a screw gear B141, idler gear B142, and motor gear B143. A flexible cable B150 electrically connects the print head B120 to a control system (to be described later).

The print head B120 shown in FIG. 8 discharges inks from the ink discharge openings B121 in accordance with an image signal while moving in the main scanning direction indicated by the arrow A together with the carriage B104, thereby printing an image of one line on the print media on the platen B103. The print operation of one line by the print head B120 and the operation of conveying the print media in the sub-scanning direction by a predetermined amount by the print media convey system (to be described later) are repeated to sequentially print images on the print media.

C-2 “Print Media Convey System”

FIG. 9 is a perspective view of the components of the print media convey system in the print unit B100. Referring to FIG. 9, reference numeral B201 denotes a pair of discharge rollers. One discharge roller B201 shown on the upper side in FIG. 9 is driven by a convey motor M002 through a discharge roller gear B202 and relay gear B203. Similarly, the above-described LF roller B101 is driven by the convey motor M002 through an LF roller gear B204 and relay gear B203. The discharge roller B201 and LF roller B101 convey the print media C104 in the sub-scanning direction indicated by the arrow B by the driving force when the convey motor M002 rotates in the forward direction.

On the other hand, when the convey motor M002 rotates in the reverse direction, a press head B213 and lock mechanism (not shown) are driven through a switching slider B211 and switching cam B212, and simultaneously, the driving force is transmitted to the paper feed roller C110 on the media pack C100 side. More specifically, by the driving force when the convey motor M002 rotates in the reverse direction, the press head B213 presses the print media C104 piled in the media pack C100 downward in FIG. 4 through a window part C102A (FIG. 4) of the shutter C102 of the media pack C100. With this operation, one of the print media C104 at the lowermost position in FIG. 4 is pressed against the paper feed roller C110 in the media pack C100. The lock mechanism (not shown) is actuated by the driving force when the convey motor M002 rotates in the reverse direction to lock the media pack C100 with respect to the body A001 and inhibit detachment of the media pack C100. Upon receiving the driving force when the convey motor M002 rotates in the reverse direction, the paper feed roller C110 on the media pack C100 side conveys one of the print media C104 at the lowermost position in the direction indicated by the arrow C.

As described above, when the convey motor M002 rotates in the reverse direction, only one of the print media C104 is picked up from the media pack C100 in the direction of arrow C in FIG. 9. Then, when the convey motor M002 rotates in the forward direction, the sheet of the print media C104 is conveyed in the direction of arrow B.

C-3 “Ink Supply System”

The joints C105 of the media pack C100 attached to the print unit B100 are located under the needles B122 (FIG. 8) on the side of the carriage B104 that has moved to the home position. The body of the print unit B100 has a joint fork (not shown) located under the joints C105. When the joint fork moves the joints C105 upward, the joints C105 are connected to the needles B122. Accordingly, ink supply paths are formed between the ink packs C103 on the media pack C100 side and the ink supply parts of the sub tank on the carriage B104 side. The body of the print unit B100 also has a supply joint (not shown) located under the supply air port B123 (FIG. 8) of the carriage B104 that has moved to the home position. This supply joint is connected to the pump cylinder (not shown) of a pump serving as a negative pressure generation source through a supply tube. The supply joint is moved upward by a joint lifter (not shown) and thus connected to the supply air port B123 on the carriage B104 side. Accordingly, negative pressure introduction paths are formed between the pump cylinder and the negative pressure introduction parts of the sub tank on the carriage B104 side. The joint lifter moves the joint fork together with the supply joint by the driving force of a joint motor M003.

Each negative pressure introduction part of the sub tank has a thin-film-shaped air/liquid separation member (not shown) which permits transmission of air and impedes transmission of ink. The air/liquid separation member permits transmission of air in the sub tank sucked through the negative pressure introduction path whereby ink is supplied from the media pack C100 to the sub tank. When the ink is sufficiently supplied until the ink in the sub tank reaches the air/liquid separation member, the air/liquid separation member impedes transmission of the ink. Hence, supply of the ink automatically stops. The air/liquid separation member is arranged at the ink supply part of each ink storage part of the sub tank for each ink and automatically stops supply of ink for each ink storage part.

The body of the print unit B100 also has a suction cap (not shown) capable of capping the print head B120 (FIG. 8) on the side of the carriage B104 that has moved to the home position. When a negative pressure is supplied from the pump cylinder into the suction cap through a suction tube, inks can be sucked and discharged (suction recovery process) from the ink discharge openings B121 of the print head B120. In addition, the print head B120 discharges ink that does not contribute to image printing into the suction cap, as needed (pre-discharge process). The ink in the suction cap is discharged to the ink absorber C107 in the paper feed roller C110 through a liquid waste tube (not shown) and a liquid waste joint (not shown).

The pump cylinder constitutes a pump unit together with a pump motor (not shown) for reciprocally driving the pump cylinder, and the like. The pump motor also functions as a driving source for vertically moving a wiper lifter (not shown). The wiper lifter moves upward the wiper C106 of the media pack C100 attached to the print unit B100, thereby moving the wiper C106 to a position where the print head B120 can be wiped.

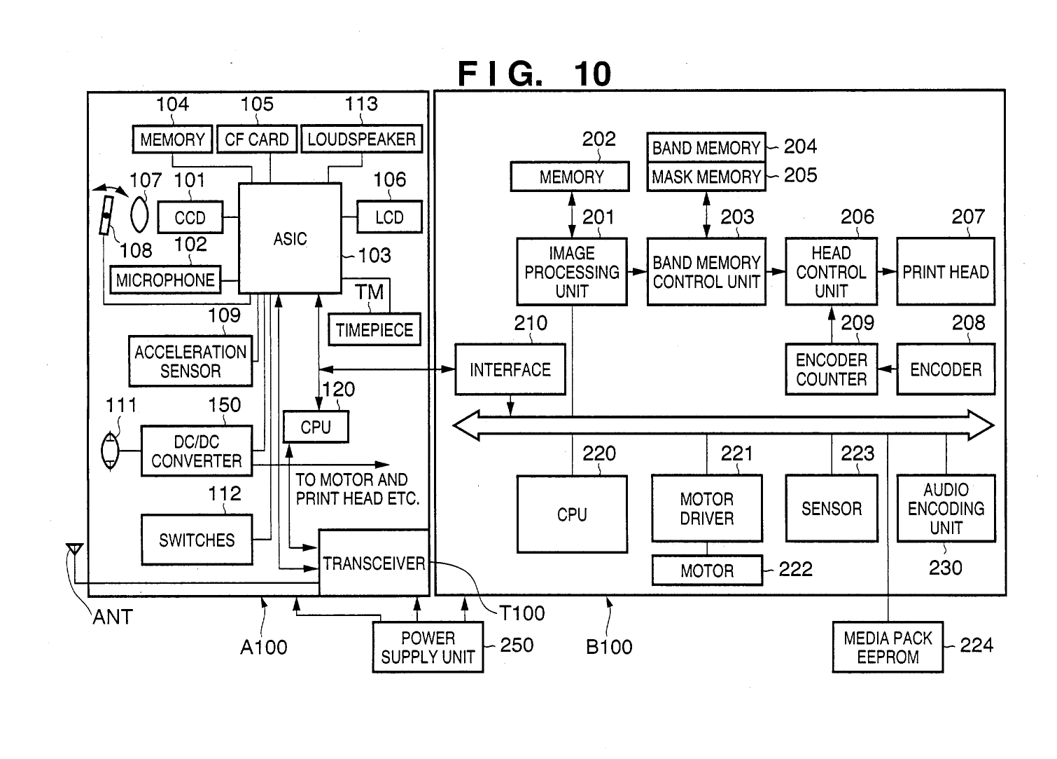

The basic arrangement of a signal processing system including a control system in this apparatus will be described next as D “signal processing system” with reference to FIGS. 10 to 20.

D “Signal Processing System”

FIG. 10 is a block diagram showing the schematic arrangement of the camera unit A100, print unit B100, and transceiver (transmitter) T100. In this example, the transceiver (transmitter) T100 executes signal communication with a device outside the body using a telephone line and, more particularly, a radio channel. The transceiver (transmitter) T100 of this embodiment includes a wire transceiver (transmitter) circuit. A transceiver (transmitter) using a communication channel other than a telephone line, such as a LAN, Bluetooth, USB, and IEEE 1394, is also included.

In the camera unit A100, reference numeral 101 denotes a CCD (Charge Coupled Device) serving as an image sensing element. It may be an image sensing element of another type (e.g., a MOS image sensor). Reference numeral 102 denotes a microphone for inputting audio data; 103, an ASIC for executing hardware processing; 104, a first memory for temporarily storing image data and the like; 105, a CF card (Compact Flash card) (corresponding to the “CF card (Compact Flash card) A107”) serving as a detachable image memory for storing a sensed image; 106, an LCD (Liquid Crystal Display) (corresponding to the “LCD (Liquid Crystal Display) display unit A105”) for displaying a sensed image or a reproduced image; 107, a lens unit (corresponding to the “lens A101”); and 108, a camera shake correction mechanism for optically correcting camera shake that occurs at the time of photographing or the like. In this embodiment, the camera shake correction mechanism 108 is designed to tilt a transparent parallel plate with the optical axis by a predetermined angle and change this angle in a direction to suppress the camera shake in accordance with the amount and direction of camera shake. As the camera shake correction mechanism, a variable-vertex-angle prism or so-called electronic anti-vibration (a technique of temporarily storing an image sensing signal in an image memory and shifting the read region from the image memory in accordance with camera shake, thereby suppressing camera shake) may be used. Reference numeral 109 denotes, e.g., an acceleration sensor as a camera shake sensor for detecting the magnitude of camera shake; 111, a photoflash unit (corresponding to the “photoflash unit A103”); 112, switches (including the “release button A104”) including various kinds of switches; 113, a loudspeaker for generating operation sound or alarm sound; 120, a first CPU for controlling the camera unit A100; and 150, a DC/DC converter as a booster circuit for causing the photoflash unit 111 to emit light. As a characteristic feature of this embodiment, the entire apparatus is made compact by using part of the boosted output from the booster circuit for the photoflash unit as a predetermined DC voltage to be supplied to the pumping motor on the printer side or for the print operation of the print head. As another characteristic feature, the boost operation (charging operation) is controlled in accordance with the operation state of the transceiver (transmitter) T100.

The camera unit A100 also has a timepiece TM for counting date information to be printed in association with each image. The ASIC 103 systematically controls, by the timepiece TM, synchronous control of the camera unit and print unit in association with various times.

In the print unit B100, reference numeral 210 denotes an interface between the camera unit A100 and the print unit B100; 201, an image processing unit (including a binarization processing unit for binarizing an image); 202, a second memory used for image processing; 203, a band memory control unit; 204, a band memory; 205, a mask memory; 206, a head control unit; 207, a print head (corresponding to the “print head B120”); 208, an encoder (corresponding to the “encoder sensor B131”); 209, an encoder counter; 220, a second CPU for controlling the entire print unit B100; 221, a motor driver; 222, a motor (including the “motors M001, M002, and M003”); 223, a sensor (including the “HP sensor (Home Position Sensor) B134”); 224, an EEPROM incorporated in the media pack C100 (a rewritable nonvolatile memory of any type can be used); 230, an audio encoding unit; and 250, a power supply unit (corresponding to the “battery A108”) for supplying power to the entire apparatus.

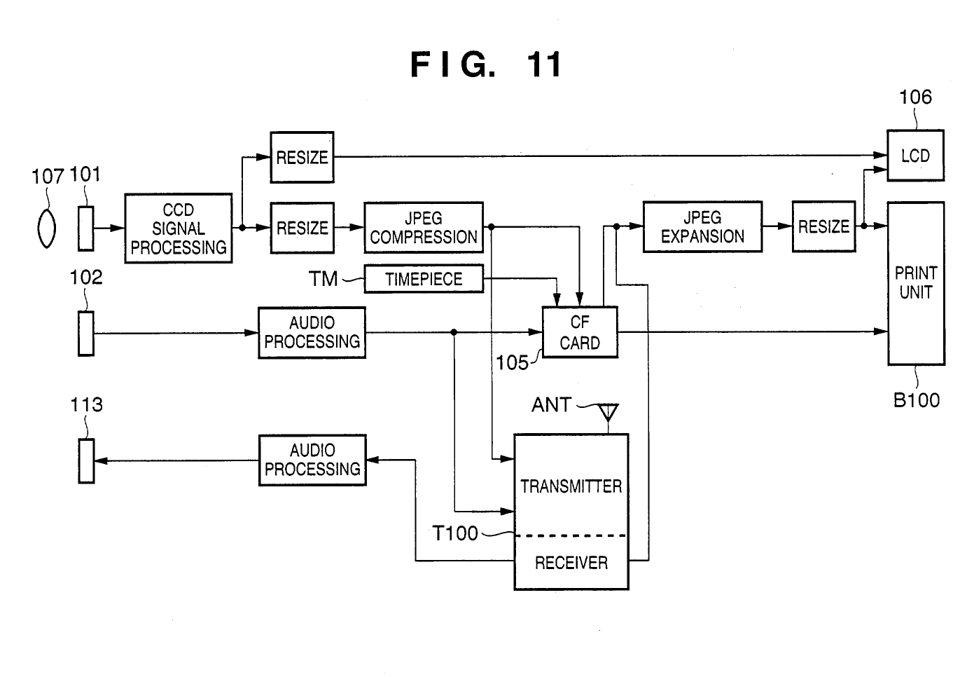

FIG. 11 is a functional block diagram of image signal processing in the camera with a printer. In a photographing mode, an image sensed by the CCD (Charge Coupled Device) 101 through the lens 107 is subjected to signal processing (CCD (Charge Coupled Device) signal processing) by the ASIC 103 and converted into a YUV luminance signal and two color difference signals. The image is also resized to a predetermined resolution, JPEG-compressed, and recorded on the CF card (Compact Flash card) 105. Alternatively, the image is transmitted to an external device. When each image is recorded on the CF card (Compact Flash card) or transmitted, date (e.g., year/month/day and time) information counted by the timepiece TM is linked to the image and recorded or transmitted. Audio data is input from the microphone 102, subjected to audio processing through the ASIC 103, and then stored in the CF card (Compact Flash card) 105 or transmitted from the transmitter to an external device. Audio data can be stored simultaneously at the time of photographing or by postrecording after photographing. In a reproduction mode, a JPEG image is read out from the CF card (Compact Flash card) 105. At the time of reception, a JPEG image is received from the receiver, JPEG-expanded by the ASIC 103, resized to a resolution for display, and displayed on the LCD (Liquid Crystal Display) 106. Audio data received by the receiver is also subjected to audio processing by the ASIC 103 and then reproduced from the loudspeaker 113.

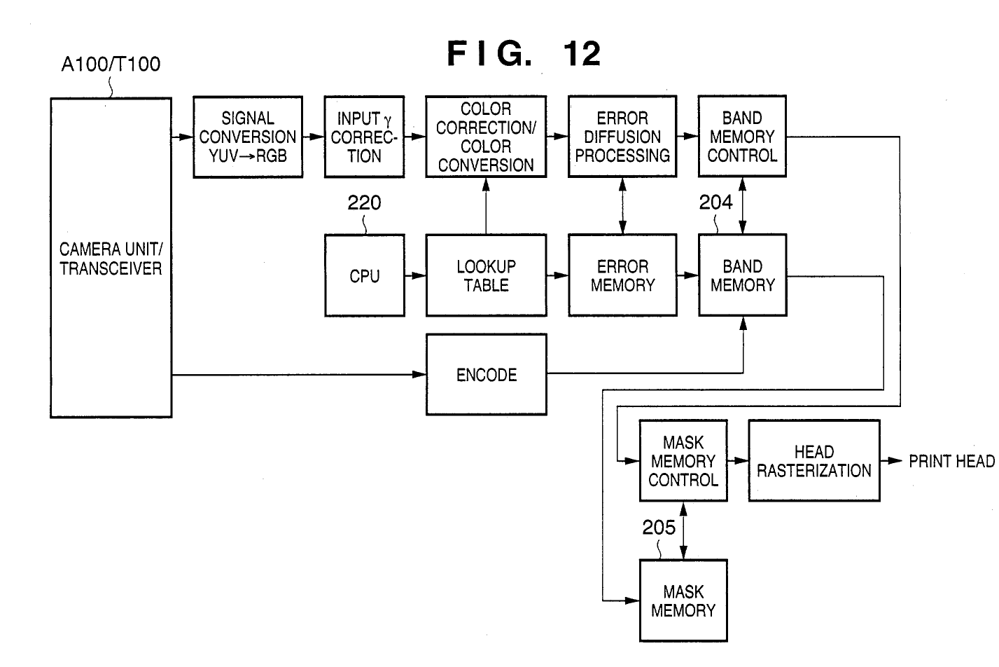

FIG. 12 is a functional block diagram of image signal processing in the print unit B100.

An image reproduced on the camera unit A100 side, i.e., an image read out from the CF card (Compact Flash card) 105 is JPEG-expanded by the ASIC 103 and resized to a resolution suitable for a print resolution, as shown in FIG. 11. The resized image data (YUV) is sent to the print unit B100 through the interface 210 shown in FIG. 10. As shown in FIGS. 10 and 12, the print unit B100 causes the image processing unit 201 to process the image data received from the camera unit A100 to convert the image data into RGB signals and execute input γ correction corresponding to the characteristics of the camera, color correction and color conversion using a lookup table (LUT) and conversion to a binary signal for printing. As color correction using the lookup table, the image data is sometimes corrected through the CPU using color correction data in the EEPROM 224 in the media pack, as will be described later.

In binarization processing, to execute error diffusion (ED) processing, the second memory 202 is used as an error memory. In this example, the binarization processing unit in the image processing unit 201 executes error diffusion processing. However, another processing such as binarization processing using a dither pattern may be executed. Binarized print data is temporarily stored in the band memory 204 by the band memory control unit 203. Every time the carriage B104 on which the print head 207 and encoder 208 are mounted moves by a predetermined distance, an encoder pulse from the encoder 208 is input to the encoder counter 209 of the print unit B100. Print data is read out from the band memory 204 and mask memory 205 in synchronism with the encoder pulse. On the basis of the print data, the head control unit 206 controls the print head 207 to perform printing.

Band memory control in FIG. 12 will be described next.

A plurality of nozzles in the print head 207 are formed in an array at a density of, e.g., 1,200 dpi. To make the carriage do main scanning once in the direction A in FIGS. 6 to 9, print data corresponding to the number of nozzles must be created in advance for the sub-scanning direction (direction B in FIGS. 6 to 9). For the main scanning direction, print data corresponding to the print area (print data corresponding to one scanning cycle) must be created in advance. Print data is created by the image processing unit 201 and temporarily stored in the band memory 204 by the band memory control unit 203. After print data corresponding to one scanning cycle is stored in the band memory 204, the carriage is scanned in the main scanning direction. At this time, encoder pulses input from the encoder 208 are counted by the encoder counter 209. The print data is read out from the band memory 204 in accordance with the encoder pulses. On the basis of the image data, ink droplets are discharged from the print head 207. When the bi-directional printing scheme of printing an image by forward and backward scanning of the print head 207 in the direction A (forward printing and backward printing) is employed, the image data is read out from the band memory 204 in accordance with the scanning direction of the print head 207. For example, in forward printing, the address of the image data read out from the band memory 204 is sequentially incremented. In backward printing, the address of the image data read out from the band memory 204 is sequentially decremented.

Actually, when the image data (C, M, and Y) created by the image processing unit 201 is written in the band memory 204, and image data of one band is prepared, scanning of the print head 207 becomes possible. The print head 207 is scanned, the image data is read out from the band memory 204, and the print head 207 prints an image on the basis of the image data. During the print operation, image data to be printed next is created by the image processing unit 201. The image data is written in a region of the band memory 204 in correspondence with the print position.

As described above, band memory control is executed while switching between the operation of writing in the band memory 204 print data (C, M, and Y) created by the image processing unit 201 and the operation of reading out the print data (C, M, and Y) in accordance with the scanning operation of the carriage to send the print data to the head control unit 206.

Mask memory control in FIG. 12 will be described next.

This mask memory control is necessary when the multipass print scheme is employed. In the multipass print scheme, a print image of one line having a width corresponding to the length of the nozzle array of the print head 207 is printed divisionally in a plurality of scanning cycles of the print head 207. More specifically, the convey amount of the print media intermittently conveyed in the sub-scanning direction is 1/N the length of the nozzle array. For example, when N=2, a print image of one line is printed divisionally in two scanning cycles (2-pass printing). When N=4, a print image of one line is printed divisionally in four scanning cycles (4-pass printing). Similarly, when N=8, 8-pass printing is executed, and when N=16, 16-pass printing is executed. Hence, a print image of one line is completed by scanning the print head 207 a plurality of number of times.

Actually, mask data used to assign image data to the plurality of scanning cycles of the print head 207 is stored in the mask memory 205. The print head 207 discharges ink to print an image on the basis of the AND data of the mask data and image data.

As shown in FIG. 11, audio data stored in the CF card (Compact Flash card) 105 is sent to the print unit B100 through the interface 210 by the ASIC 103, like image data. The audio data sent to the print unit B100 is encoded by the audio encoding unit 230 and subjected to predetermined modulation as two-dimensional bar code data in the printed image, and thus, printed as “watermark” information. If the audio data need not be inserted in the printed image, or an image without any audio data is to be printed, the audio data converted into two-dimensional bar code data is not printed. Only the image is printed.

In this embodiment, media pack expendable management control for managing degradation in expendables, i.e., inks and print media in the media pack C100, anti-vibration control in the photographing mode using the camera shake sensor 109 and carriage control in the printer mode, and power supply control in which the DC/DC converter 150 as a boosting means for causing the photoflash unit to emit light in the camera unit A100 is used as a printing or pumping power supply of the print head 207 of the print unit B100 are executed.

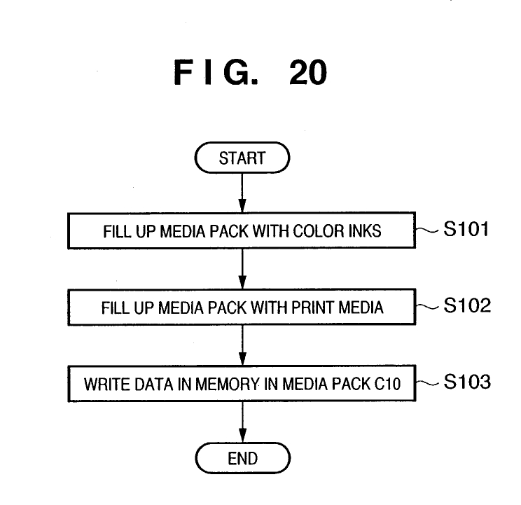

The media pack expendable management control will be described first. FIG. 20 is a flow chart showing the expendable replenishment (fill-up) procedure of the media pack C100.

The media pack C100 in this embodiment is designed to be capable of replenishing itself with expendables such as inks and print media and also writing data related to the expendables and replenishment in the EEPROM 224. The data of the residual amounts of the expendables or date data such as year/month/day when the expendables are filled up or manufactured, which are written in the EEPROM 224, are updated every time the expendables decrease or the media pack is replenished (filled up) with the expendables, and used to manage the expendables in the media pack C100.

To replenish (fill up) the media pack C100 with the expendables, the media pack C100 is brought into a factory or print shop, and the media pack C100 is, e.g., manually replenished (filled up) with the expendables by a worker in the factory or print shop. In replenishing (filling up) the media pack with the expendables, as shown in FIG. 20, first, the ink packs C103 of the respective colors (Y, M, and C) in the media pack C100 are filled up with the inks in step S101. In step S102, the media pack C100 is filled up with the print media C104. In step S103, data of the date (year/month and/or day/time) when the media pack is replenished (filled up) with the expendables, or the expendables are manufactured, characteristic data (color characteristic data, data related to viscosity, and the like) of the supplied inks, residual ink amount data, characteristic data (e.g., data related to the material such as gloss paper, neutral paper, or recycled paper, data related to the ground color, and the like) of the print media, data of the remaining number of print media, and degradation characteristic data of inks (a lookup table in which the relationship between the elapsed period and the change in color is described as a linear matrix coefficient, and the like) are written in the EEPROM 224 in the media pack C100 by a memory writing device. Instead of storing lookup table data itself in the EEPROM 224, a plurality of kinds of lookup table for color correction may be stored in advance in the lookup table shown in FIG. 12, and data that represents which table should be selected in accordance with the degradation in expendables may be stored in the EEPROM 224, the memory in the camera unit, or the memory in the print unit.

When replenishment (fill-up) of the media pack C100 with the expendables is thus ended, the media pack C100 is sent out or directly handed to the user. The media pack C100 shipped from a factory as a product also has the same data as described above.

At the time of use of the media pack C100, the data related to the expendables, which are written in the EEPROM 224, are read out, and expendable management is done using the readout data. Accordingly, for example, degradation in expendables can be estimated on the basis of the data, and warning and color correction or the like can be done on the basis of the estimation result.

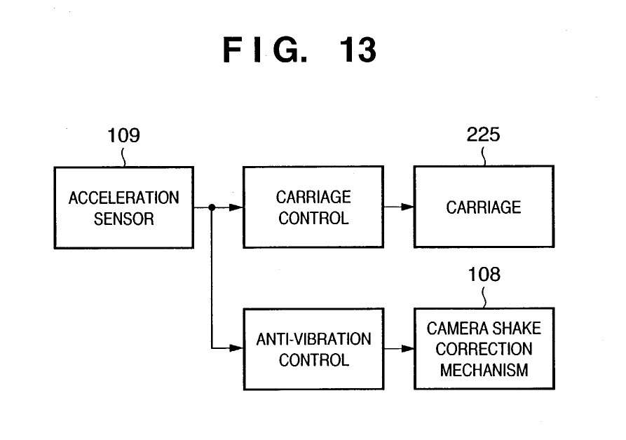

Next, anti-vibration in the photographing mode and carriage control in the printer mode will be described. FIG. 13 is a functional block diagram of anti-vibration control in the photographing mode in the camera unit and carriage control in the printer mode.

In this embodiment, in the photographing mode, anti-vibration control is executed to suppress any image blur due to camera shake on the basis of the output signal of the acceleration sensor 109. In this anti-vibration control, the amount and direction of camera shake are detected on the basis of the output signal of the acceleration sensor 109, and the correction amount of the camera shake correction mechanism 108 is controlled on the basis of the amount and direction of camera shake. More specifically, a control variable that changes the incident optical path to the lens 107 in a direction in which an image blur due to camera shake is suppressed is calculated as a correction amount. On the basis of this correction amount, the camera shake correction mechanism 108 is driven and controlled. With this operation, the image blur due to camera shake is corrected, and image data without any blur can be obtained.

In the printer mode, carriage control is performed to detect a camera shake amount on the basis of the output signal of the acceleration sensor 109 and temporarily stop print operation in accordance with the camera shake amount. In this carriage control, more specifically, when the detected camera shake amount is larger than a predetermined amount, a command for stopping a carriage 225 at a predetermined position (the scanning start position or scanning end position in the main scanning direction) is sent to the print unit B100. Upon receiving this command, the print unit B100 controls the motor for driving the carriage 225 to temporarily stop the carriage 225 at the predetermined position.

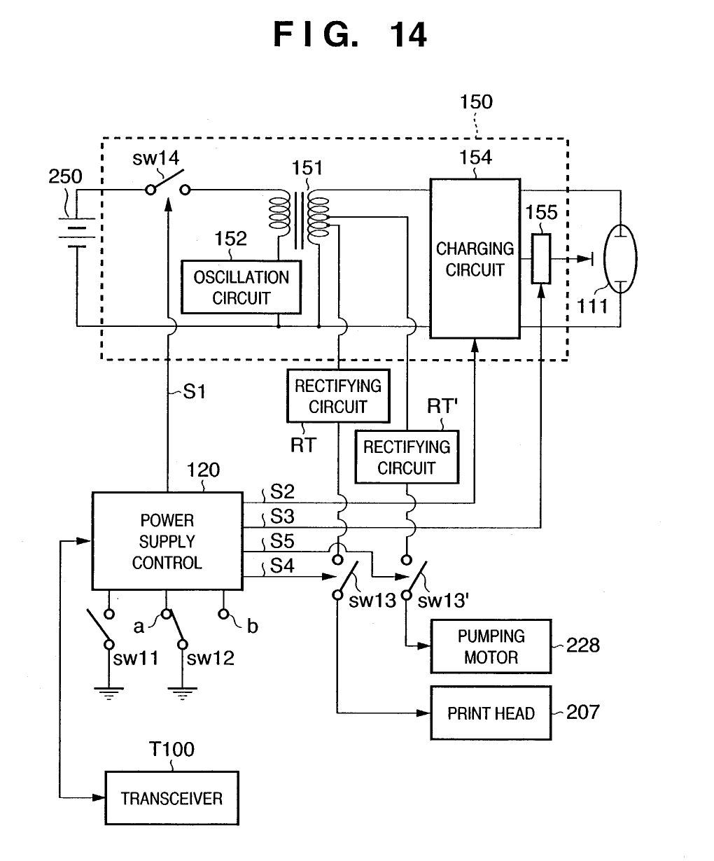

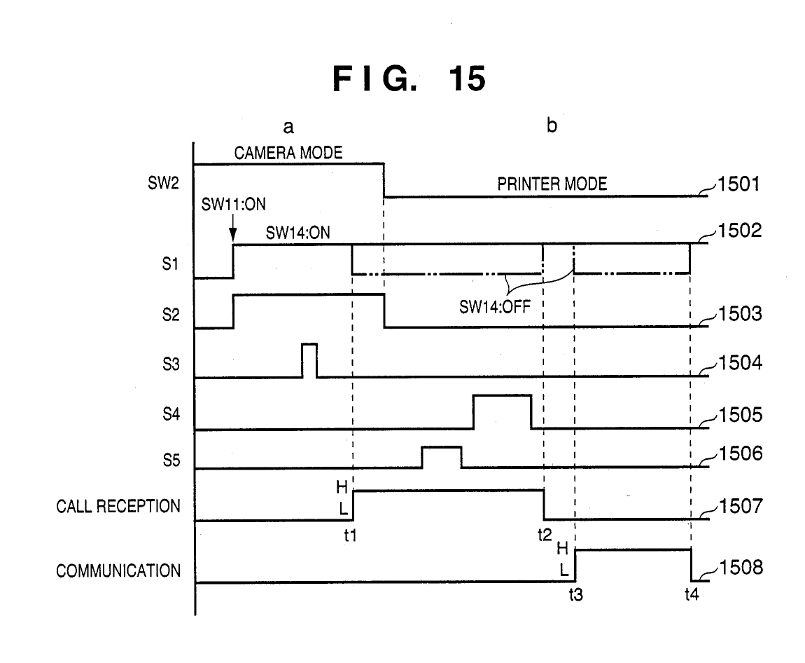

Next, power supply control in which the DC/DC converter 150 as a boosting means for causing the photoflash unit to emit light is used as a printing or pumping boost power supply of the print head 207 of the print unit B100 will be described. FIG. 14 is a functional block diagram of power supply control in which the DC/DC converter 150 for causing the photoflash unit to emit light is used as a printing or pumping boost power supply of the print head 207 of the print unit B100. FIG. 15 is an output timing chart of drive signals S1 to S5 in the power supply control shown in FIG. 14.

As shown in FIG. 14, the DC/DC converter 150 is constituted by a transformer 151 whose primary side receives a voltage from the power supply unit 250 through a switch (SW) 14, an oscillation circuit 152, a charging circuit 154 for generating and rectifying a predetermined high voltage from the secondary side voltage of the transformer 151 to the photoflash unit 111 to charge the photoflash unit 111, and a trigger 155 for applying a predetermined trigger voltage to the photoflash unit 111. On the secondary side of the transformer 151, the voltage to the charging circuit 154, the driving voltage of the print head 207 of the print unit B100, and the driving voltage of the pumping motor 228 of the head are output from the respective output terminals through corresponding rectifying circuits RT and RT′. The driving voltage of the print head 207 is supplied to the print head 207 through a switch SW13. The driving voltage of the pumping motor 228 is supplied to the motor 228 through a switch SW13′. The operations of the switches SW13, SW13′, and SW14, charging circuit 154, and trigger 155 are controlled in accordance with the power supply control by the first CPU 120 of the camera unit A100. More specifically, when a power switch SW11 of the camera with a printer is turned on, the drive signal S1 is output to the switch SW14 to turn on the switch SW14 ((1502) in FIG. 15). It is determined on the basis of an output from a mode change-over switch SW12 whether the currently set mode is the camera mode or printer mode. When the mode change-over switch SW12 is set on a side a, it is determined that the camera mode is set. When the mode change-over switch SW12 is set on a side b, it is determined that the printer mode is set. In this example, as indicated by (1501) in FIG. 15, when the power switch SW11 is turned on, the camera mode is set as default setting.

When the camera mode is set, the drive signal S2 for instructing to start driving the charging circuit 154 as preparation operation for light emission of the photoflash unit 111 is output to the charging circuit 154 ((1503) in FIG. 15). The drive signal S3 for causing the photoflash unit 111 to emit light is output to the trigger 155 at a predetermined photographing operation timing ((1504) in FIG. 15). Thus, the photoflash unit 111 emits light.

To print an image sensed by the user, the printer mode is set by switching the mode change-over switch SW12 by the user ((1501) in FIG. 15). When the printer mode is set, the drive signal S4 is output to the switch SW13 in synchronism with the print operation timing of the print head 207 in the print operation ((1505) in FIG. 15) Accordingly, the switch SW13 is turned on to supply the driving voltage of the print head 207 from the DC/DC converter 150 to the print head 207 through the rectifying circuit RT. When the drive signal S5 is output to the switch SW13′ for ink pumping operation ((1506) in FIG. 15), the switch SW13′ is turned on to supply the driving voltage from the DC/DC converter 150 to the pumping motor 228 through the rectifying circuit RT′.

As described above, when the printer mode is set, the driving voltage for printing or pumping of the print head 207 is supplied from the DC/DC converter 150 to the print head 207 or motor 228 through the rectifying circuit RT or RT′. With this arrangement, no driving voltage supplying booster circuit for printing or pumping of the print head 207 needs to be independently arranged. Hence, the arrangement is simplified, and the size of the apparatus can largely be reduced.

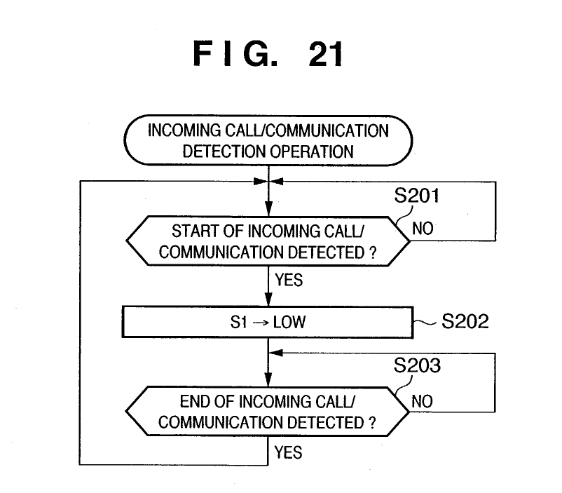

In this embodiment, upon detecting an incoming call, as indicated by H of (1507) in FIG. 15 (t1 to t2) or during communication as indicated by H of (1508) in FIG. 15 (t3 to t4), the CPU 120 changes the drive signal S1 to low level and turns off the switch SW14. Hence, the boost operation is limited (stopped). Instead of completely stopping the boost operation, it may be limited by decreasing the driving current of the DC/DC converter 150. The boost operation may be limited only upon detecting an incoming call. This operation is performed by an interrupt operation (incoming call/communication detection operation) flow as shown in FIG. 21.

More specifically, when an incoming call or the start of communication is detected in step S201, the drive signal S1 is changed to low level in step S202. In step S203, detection of the end of the incoming call or communication is waited. Upon detecting the end of the incoming call or communication, the flow returns to step S201.

The boost operation may be limited not by turning off the switch SW14 but by turning off the oscillation circuit 152 or decreasing the current of the oscillation circuit 152.

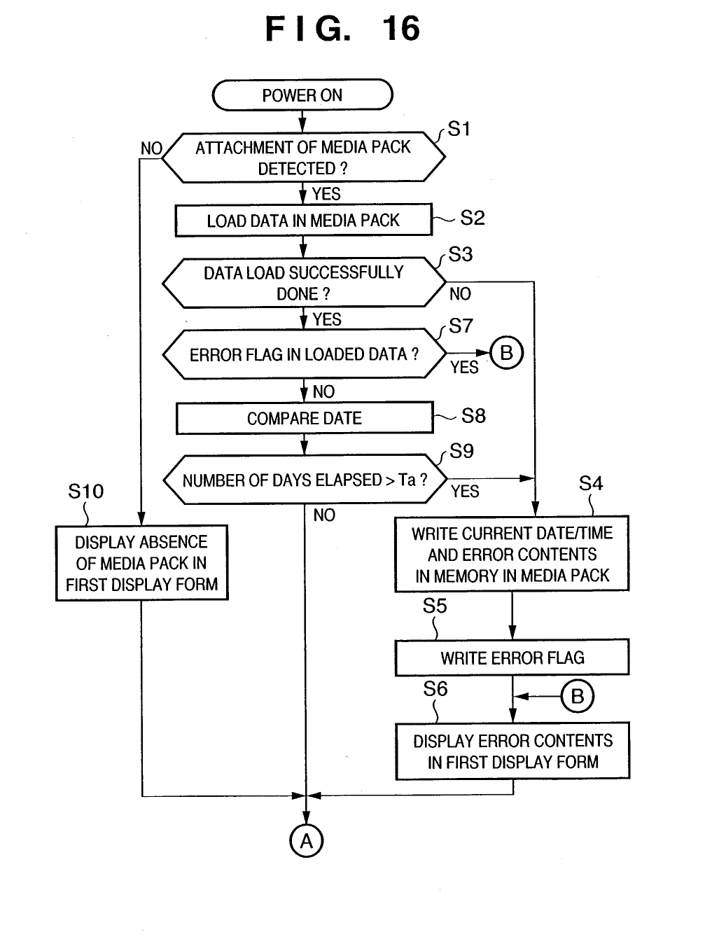

The operation of this apparatus will be described next. FIGS. 16 to 19 are flow charts showing the operation procedure of the camera with a printer.

When the camera power supply is turned on, as shown in FIG. 16, it is detected first in step S1 on the basis of the output from a media pack attachment detection switch (not shown) whether the media pack is attached. If YES in step S1, the flow advances to step S2 to load various kinds of data stored in the memory (EEPROM 224) in the media pack. The flow advances to step S3 to determine whether data loading has been successfully done.

If data loading fails, i.e., if communication with the memory in the media pack fails (e.g., when the data in the memory cannot be correctly read because of a mechanical connection error between the electrical contact of the media pack and that on the camera body side or when it is determined that communication fails because the data from the memory contains noise or the like although the electrical connection is correctly done), the flow advances to step S4 to store the current date/time (e.g., year/month/day (and additionally, e.g., time)) in the memory in the media pack and also store the error contents in association with the date/time data. In this case, since the communication fails, “communication-error” is stored as error contents.

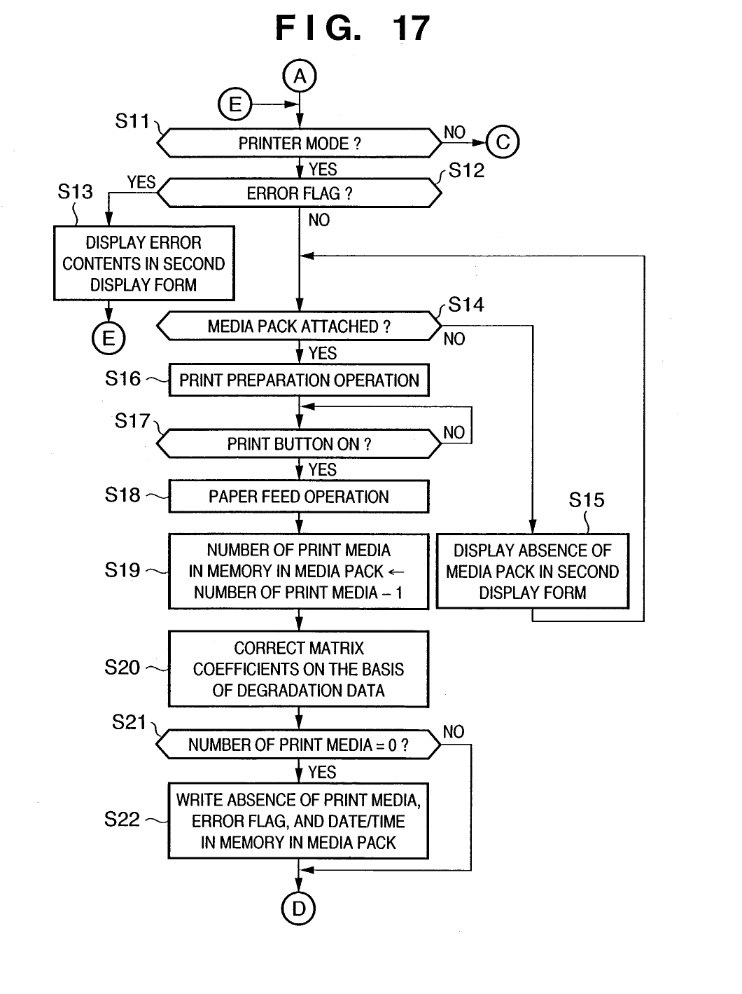

Then, the flow advances to step S5 to write an error flag in the memory in the media pack. In step S6, the error contents are displayed on the LCD (Liquid Crystal Display) 106 in the first display form. In this first display form, for example, the error contents are indicated by a predetermined mark or character. The flow advances to step S11 shown in FIG. 17.

If no communication error has occurred in step S3, the flow advances to step S7 to determine whether the data loaded from the memory in the media pack has an error flag. An error flag is a flag that is written in the memory in the media pack together with the error contents when the error corresponds to at least one of the cases in which, for example, no ink remains, no paper sheets as print media remain, and inks or paper has not been used for a predetermined period or more.

When the error flag is detected in step S7, the flow advances to step S6 to display the error contents on the LCD (Liquid Crystal Display) 106 in the first display form. Then, the flow advances to step S11 shown in FIG. 17.

If no error flag is detected in step S7, it is determined that the data loaded from the memory in the media pack C100 is normal data. The flow advances to step S8 to detect, on the basis of the loaded data, the date (e.g., year/month/day) when the media pack is refilled (filled up) with inks and/or, e.g., paper sheets as the print media, or the inks and/or paper sheets are manufactured. The date (e.g., year/month/day) of refill (fill-up) or manufacturing is compared with the date (e.g., year/month/day) of the timepiece TM of the camera body. It is determined in step S9 whether the comparison result (the difference between the dates) is large than a predetermined value Ta (e.g., two years). When the difference is larger, i.e., two years have elapsed after refill (fill-up) or manufacturing, it is determined that the inks as expendables or print media such as paper sheets as expendables degrade. The flow advances to step S4 to store in the memory in the media pack error contents representing that the inks or print media degrade. In addition, the date and time counted by the timepiece TM in the camera unit are stored in association with the error contents. In step S5, an error flag is written in the memory in the media pack. In step S6, the error contents are displayed on the LCD (Liquid Crystal Display) 106 serving as a display means in the first display form. The flow advances to step S11 shown in FIG. 17.

If it is determined in step S9 that the difference is equal to or smaller than the predetermined value Ta, the flow advances to step S11 shown in FIG. 17. If it is detected in step S1 that no media pack is attached, that no media pack is attached is displayed on the LCD (Liquid Crystal Display) 106 in the first display form. The first display form at this time is display of a warning level like the first display form in step S6. Then, the flow advances to step S11 shown in FIG. 17.

In step S11, it is determined whether the current mode is the printer mode. If YES in step S11, the flow advances to step S12 to determine whether an error flag is present in the memory in the media pack. If YES in step S12, the flow advances to step S13 to display the error contents on the LCD (Liquid Crystal Display) 106 in the second display form and generate, e.g., warning sound. The second display form is different from the first display form, in which the warning level is raised to help recognition. For example, when the error contents are to be displayed using the same mark or character as in the first display form, the error contents are displayed using a larger mark or character such that they can more easily be recognized. In addition, a sound is used to more easily make the operator aware of the error. When a sound is used in the first display form, the volume is increased in the second display form for easier recognition. Then, the flow returns to step S11. If NO in step S12, the flow advances to step S14 without executing step S13.

It is determined in step S14 again whether the media pack is attached. If NO in step S14, the flow advances to step S15 to display the absence of media pack in the second display form (i.e., the display form in which a larger mark or character, or a sound is used for easier recognition). The flow returns to step S14 to wait until the media pack is attached.

If attachment of the media pack is detected in step S14, the flow advances to step S16 to execute printer preparation operation of opening the cap of the ink packs of the media pack, connecting the negative pressure nozzles, and executing recovery pumping operation and the like. In this embodiment, this preparation operation is performed after the printer mode is set. Hence, wasteful consumption of power and inks can be greatly reduced as compared to a case wherein the operation in step S16 in accordance with attachment of the media pack or ON operation of the main power of the camera.

Then, the flow advances to step S17 to wait until the print button is pressed. When the button is pressed, the flow advances to step S18 to drive the paper feed roller to feed one of the print media, i.e., a paper sheet from the media pack. The flow advances to step S19 to update the number of print media in the memory in the media pack by decrementing the number by one. In step S20, linear matrix conversion of the print color is performed using the coefficient data of the color correction matrix stored in the memory in the media pack. The change characteristics of ink colors (e.g., yellow, cyan, and magenta) corresponding to the number of years/months (days) that elapse after refill (fill-up) or manufacturing are measured in advance, and linear matrix coefficients (e.g., 3×3=9 matrix coefficients that are calculated by matrix operation for yellow, cyan, and magenta after correction) used to correct the change characteristics are stored as a lookup table in the memory in the media pack. Alternatively, as described above, a plurality of tables are stored in the lookup table shown in FIG. 12, and data that represents which table should be selected in accordance with degradation is stored in the EEPROM 224 or the memory in the camera unit or print unit. Hence, when the number of years/months (days) that have elapsed is determined in step S9, optimum printing can be performed by correcting the change in characteristic of each ink color in correspondence with the number of years/months (days) that have elapsed. In the above and subsequent embodiments, year/month/day information and also time information are exemplified as date/time information. The date/time information need not always contain information of time or day. Information capable of specifying time suffices. Only year information, only year/month information, or only year/month/day information, may be used. Alternatively, all pieces of information of year/month/day/hour/minute/second may be contained.

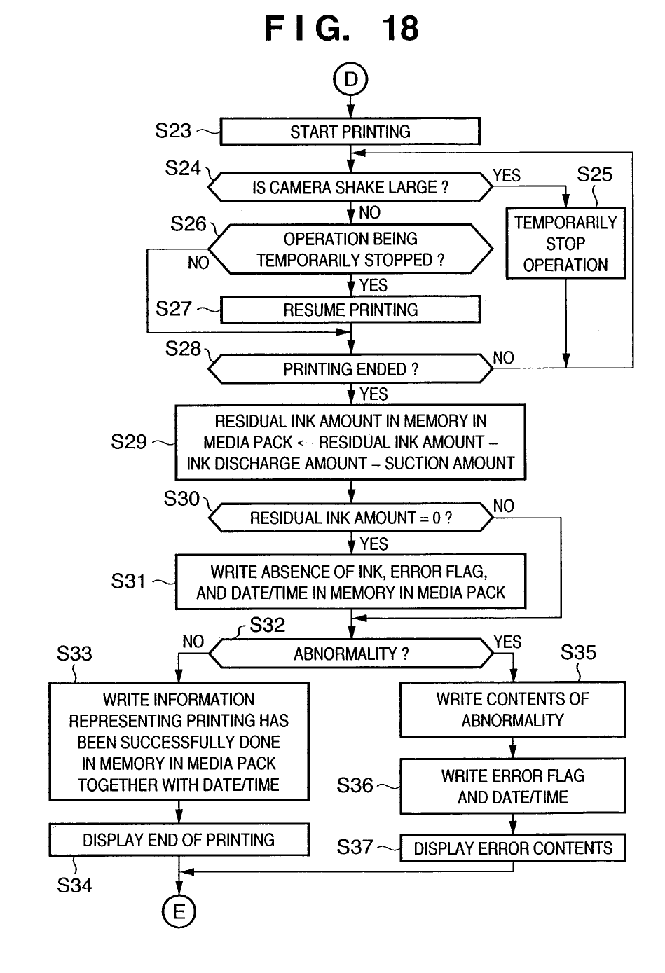

Then, the flow advances to step S21 to determine whether the remaining number of print media, which is updated in step S19, is zero. If YES in step S21, the flow advances to step S22 to write error information representing that no print media are present anymore in the memory in the media pack and also write an error flag. Date (year/month/day and time) information counted by the timepiece TM in the camera unit is also linked to the error contents and stored. The flow advances to step S23 shown in FIG. 18. If the updated remaining number of print media is not zero, the flow advances to step S23 shown in FIG. 18 without executing step S22.

In step S23, print operation is started. In step S24, it is detected using the acceleration sensor 109 whether the camera shake amount is larger than a predetermined amount. If YES in step S24, the flow advances to step S25 to temporarily stop the print operation. At this time, control is performed to temporarily stop the operation when the carriage 225 of the print unit B100 is at the main scanning end. Processing waits until the camera shake amount decreases. Hence, when the camera shake decreases, and printing is resumed, the shift in print is unnoticeable.

When the camera shake amount is equal to or smaller than the predetermined amount, the flow advances to step S26 to determine whether the operation is being temporarily stopped. If YES in step S26, the print operation is resumed, and the flow advances to step S28. If NO in step S26, the flow advances to step S28 without executing step S27. It is determined in step S28 whether one paper sheet has been printed. If NO in step S28, the flow returns to step S24. If YES in step S28, the flow advances to step S29 to update the residual ink amount data in the memory in the media pack is updated. More specifically, the data is updated to a value obtained by subtracting the ink discharge amount (this data is obtained not by measuring the actually discharged ink amount but by calculating on the basis of image data the ink amount of each color to be used) and the ink amount (this amount is almost constant) supplied into the sub tank in the print head 207 from the residual ink amount data in the memory in the media pack.

Then, the flow advances to step S30 to determine whether one of the color inks has run short (it does not always mean that the ink amount is zero but that the ink amount is equal to or smaller than a predetermined amount). If YES in step S30, error contents representing that the ink has run short are written, and an error flag is written in step S31. Year/month/day (and time) counted by the timepiece TM in the camera unit at this time are linked to the error contents and stored.

It is determined in step S32 whether the print operation has an abnormality (e.g., when printing has failed halfway due to camera shake or large vibration, or a specific color could not be printed due to clogging in the print head). If NO in step S32, the flow advances to step S33 to write information representing that printing has been successfully done in the memory in the media pack in association with the date (time) counted by the timepiece TM in the camera unit. In step S34, that the printing has been normally ended is displayed on the LCD (Liquid Crystal Display) 106, and the flow returns to step S11.

If an abnormality in the print operation is detected in step S32, the flow advances to step S35 to write the contents of the abnormality in the memory in the media pack. In step S36, an error flag is written, and the date (and time) counted by the timepiece TM in the camera unit are also written in association with the error contents. The flow advances to step S37 to display the error contents on the LCD (Liquid Crystal Display) 106 and then returns to step S11.

As described above, in this embodiment, various kinds of error contents and the year/month/day or time counted by the timepiece TM in the camera unit are linked to each other and stored in the memory in the media pack. For this reason, when the pack is collected later or is to be repeatedly used, repair of the media pack or data correction can be appropriately done. In addition, information for improvement of the media pack can be collected.

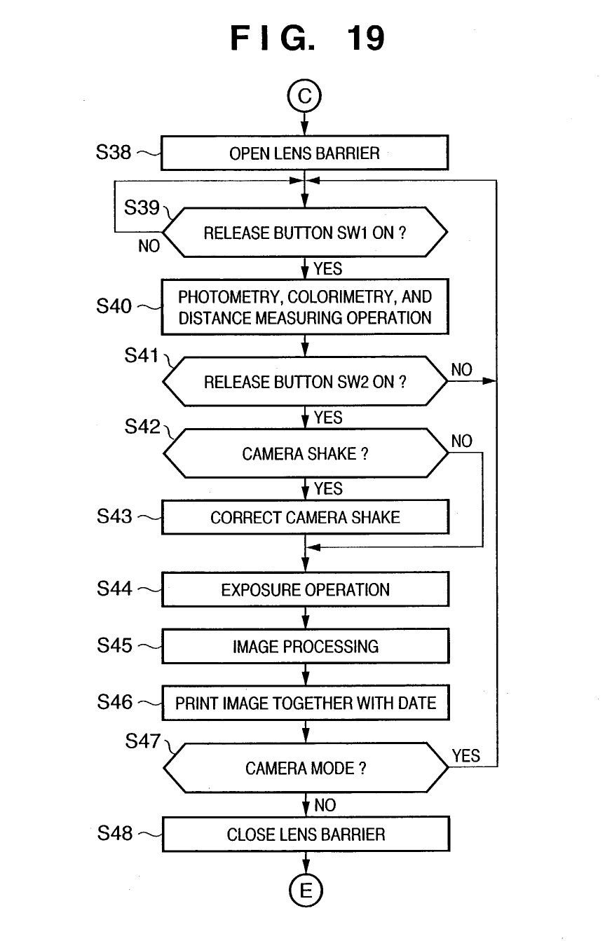

When it is determined in step S11 (FIG. 17) that the current mode is not the printer mode but the camera mode, the flow advances to step S38 shown in FIG. 19 to open, by a plunger, a lens barrier (not shown) provided in front of the lens 107. In step S39, processing waits until the release button is pressed to the first stroke position, i.e., a switch SW1 is turned on. When the switch SW1 of the release button is turned on, the flow advances to step S40 to execute measuring operation such as photometry, colorimetry, and distance measuring operation.

Then, the flow advances to step S41 to wait until the release button is pressed to the second stroke position, i.e., a switch SW2 is turned on. If NO in step S41, the flow returns to step S39. If YES in step S41, the flow advances to step S42. In step S42, the amount and direction of camera shake are detected on the basis of the output from the acceleration sensor 109. It is determined in step S43 whether the camera shake amount is larger than a predetermined amount to determine whether camera shake is present. If YES in step S43, the flow advances to step S43 to drive the camera shake correction mechanism 108 in accordance with the amount and direction of camera shake to correct the image blur. Then, the flow advances to step S44. If no camera shake is present, the flow advances to step S44 without executing step S43.

In step S44, exposure operation is executed using the stop and shutter whereby exposure in a predetermined amount is performed for the CCD (Charge Coupled Device) 101. The flow advances to step S45 to execute image processing such as white balance, gamma correction, color correction, and compression. In step S46, the image is stored in the CF card (Compact Flash card) 105. At this time, date/time information counted by the timepiece TM in the camera unit is linked to each image and recorded.

The flow advances to step S47 to determine whether the mode is the camera mode. If YES in step S47, the flow returns to step S39. If NO in step S47, the lens barrier is closed in step S48, and then, the flow returns to step S11.

(Other Embodiment)

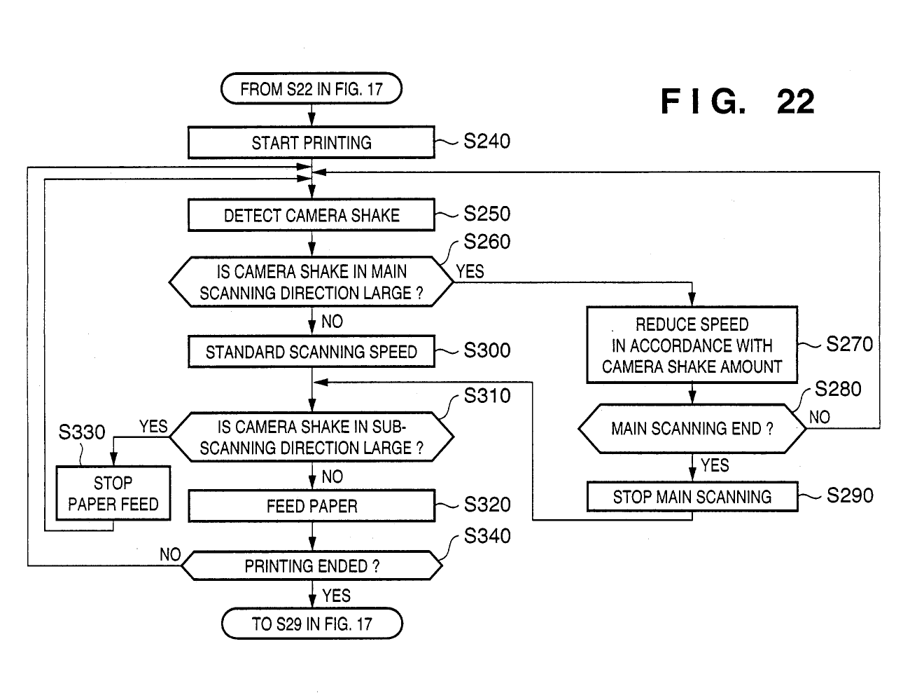

Other embodiment of the present invention will be described with reference to FIG. 22. FIG. 22 is a flow chart showing the operation procedure of a camera with a printer according to other embodiment of the present invention.

This embodiment is different from the above-described embodiment in that in carriage control using an acceleration sensor 109, the running speed of a carriage 225 and paper feed are controlled on the basis of the magnitude of a camera shake amount in a predetermined direction.

More specifically, as shown in FIG. 22, print operation is started in step S240 (corresponding to step S23 in FIG. 18). In step S250, the amount and direction of camera shake are detected using the acceleration sensor 109. In step S260, the camera shake component amount in the main scanning direction is obtained from the amount and direction of camera shake. It is determined whether the camera shake component amount is larger than a predetermined amount. If the camera shake component amount in the main scanning direction is larger than the predetermined amount, the flow advances to step S270 to reduce the current running speed of the carriage 225 in accordance with the camera shake component amount in the main scanning direction. More specifically, a deceleration amount for the running speed of the carriage 225 is set in accordance with the camera shake component amount in the main scanning direction. The running speed of the carriage 225 is controlled in accordance with the set deceleration amount. If the camera shake component amount has an almost medium magnitude, a small deceleration amount is set to suppress a decrease in printing efficiency as much as possible. If the camera shake component amount is large, a large deceleration amount is set to suppress the degree of influence on the deviation of running speed within a predetermined range and suppress the error in landing position, on a paper sheet, of an ink discharged from a print head 207 to a predetermined amount or less.

Then, the flow advances to step S280 to detect the current position of the print head 207 and determine whether the print head 207 is at the main scanning end. If NO in step S280, the flow returns to step S250 to detect the camera shake amount again. If YES in step S280, the flow advances to step S290 to temporarily stop the carriage 225 and temporarily interrupt main scanning. The flow advances to step S310 to obtain the camera shake component in the sub-scanning direction from the camera shake amount and determine whether the camera shake component is larger than a predetermined amount.

If the camera shake component in the sub-scanning direction is larger than the predetermined amount, the flow advances to step S330 to stop paper feed. The flow returns to step S250 to detect the camera shake amount again. If the camera shake amount in the sub-scanning direction is equal to or smaller than the predetermined amount, the flow advances to step S320 to feed the paper sheet by a predetermined amount. In step S340, it is determined whether the print position has reached the sub-scanning end to determine whether one paper sheet has been printed. If the print position has not reached the sub-scanning end, printing is not ended yet. Hence, the flow returns to step S250 to detect the camera shake amount again.

When the camera shake component amount in the main scanning direction is equal to or smaller than a predetermined amount in step S260, the flow advances to step S300 to drive the carriage 225 at a standard speed. That is, main scanning is performed at a standard scanning speed. If the current running speed is being reduced, it is returned to the standard speed. In steps S310 to S330, paper feed is stopped or continued in accordance with the camera shake component in the sub-scanning direction.

When one paper sheet is printed in step S340, the same processing as that from step S29 shown in FIG. 18 is executed.

In the above-described embodiments, the camera with a printer in which the camera unit A100 and print unit B100 are integrated has been described. However, even in an arrangement in which the camera unit A100 and print unit B100 are separated and connected by the interface 210, the same function as described above can be implemented by the same arrangement as described above.

As has been described above, according to the present invention, the apparatus can be made considerably compact. In addition, since any operation error in image sensing or printing at the time of call incoming or communication or any crosstalk during communication can be effectively prevented, the apparatus operation can be stabilized, and the communication reliability can be increased.

As many apparently widely different embodiments of the present invention can be made without departing from the spirit and scope thereof, it is to be understood that the invention is not limited to the specific embodiments thereof except as defined in the appended claims.

1. A camera with a printer, comprising:
image sensing means for sensing an object image;
communication means for communicating a signal with an external device;
a photoflash unit;
a printer which prints an output image from said image sensing means;
a battery which supplies power to at least said photoflash unit;
Dc power supply means having a common booster circuit which receives the power supplied from said battery and supplies a driving dc power of said photoflash unit and a printing or pumping dc power of said printer; and
limiting means for limiting boost operation in the booster circuit while communication is being executed by said communication means.

2. The camera according to claim 1, wherein said DC power supply means exclusively supplies the driving DC power of said photoflash unit and the printing or pumping DC power of said printer.

3. The camera according to claim 2, wherein the camera comprises mode setting means for selectively setting a camera mode and a printer mode, and said DC power supply means supplies the driving DC power of said photoflash unit using the common booster circuit when the camera mode is set and supplies the printing or pumping DC power of said printer using the common booster circuit when the printer mode is set.

4. The camera according to any one of claims 1 to 3, wherein said DC power supply means has a common boosting DC/DC conversion circuit which receives the power from said battery and outputs from separate terminals a DC voltage as the driving DC power of said photoflash unit and a DC voltage as the printing or pumping DC power of said printer.

5. The camera according to claim 1, wherein said limiting means stops the boost operation of the booster circuit while communication is being executed by said communication means.

6. The camera according to claim 1, wherein said limiting means makes a current of the booster circuit while communication is being executed by said communication means smaller than that while communication is not being executed.

7. The camera according to claim 1, wherein a timing while communication is being executed by said communication means includes a timing of call reception.

8. A communication apparatus comprising:
image sensing means for sensing an object image;
communication means for communicating a signal with an external device;
illumination means for illuminating an object;
boosting means for supplying a power of said illumination means; and
limiting means for limiting boost operation of said boosting means while communication is being executed by said communication means.

9. The apparatus according to claim 8, wherein said limiting means stops the boost operation of said boosting means while communication is being executed by said communication means.

10. The apparatus according to claim 8, wherein said limiting means makes a driving current of said boosting means while communication is being executed by said communication means smaller than that while communication is not being executed.

11. The apparatus according to claim 8, wherein a timing while communication is being executed by said communication means includes a timing of call reception.

12. The apparatus according to claim 8, further comprising a printer which prints an output image from said image sensing means.

13. A communication apparatus comprising:
image sensing means for sensing an object image;
detection means for detecting reception of a signal from an external device;
illumination means for illuminating an object;
boosting means for supplying a power of said illumination means; and
limiting means for limiting boost operation of said boosting means when reception of the signal from the external device is detected by said detection means.

14. The apparatus according to claim 13, wherein said limiting means stops the boost operation of said boosting means when reception of the signal from the external device is detected by said detection means.

15. The apparatus according to claim 13, wherein when reception of the signal from the external device is detected by said detection means, said limiting means makes a driving current of said boosting means smaller than that while no signal is being received.

16. The apparatus according to claim 13, further comprising a printer which prints an output image from said image sensing means.

17. A control method of controlling a communication apparatus comprising image sensing means for sensing an object image, communication means for communicating a signal with an external device, illumination means for illuminating an object, boosting means for supplying a power of said illumination means, and control means for controlling the image sensing means, the communication means, the illumination means, and the boosting means, comprising:
the limiting step of causing the control means to limit boost operation of the boosting means while communication is being executed by the communication means.

18. The method according to claim 17, wherein in the limiting step by the control means, the boost operation of the boosting means is stopped while communication is being executed by the communication means.

19. The method according to claim 17, wherein in the limiting step by the control means, a driving current of the boosting means while communication is being executed by the communication means is made smaller than that while communication is not being executed.

20. The method according to claim 17, wherein a timing while communication is being executed by the communication means includes a timing of call reception.

21. The method according to claim 17, wherein the communication apparatus further comprises a printer which prints an output image from the image sensing means.

22. A control program for controlling a communication apparatus comprising image sensing means for sensing an object image, communication means for communicating a signal with an external device, illumination means for illuminating an object, boosting means for supplying a power of said illumination means, and control means for controlling the image sensing means, the communication means, the illumination means, and the boosting means, wherein the control means is caused to execute the limiting step of limiting boost operation of the boosting means while communication is being executed by the communication means.

23. The program according to claim 22, wherein in the limiting step, the boost operation of the boosting means is stopped while communication is being executed by the communication means.

24. The program according to claim 22, wherein in the limiting step, a driving current of the boosting means while communication is being executed by the communication means is made smaller than that while communication is not being executed.

25. The program according to claim 22, wherein a timing while communication is being executed by the communication means includes a timing of call reception.

26. The program according to claim 22, wherein the communication apparatus further comprises a printer which prints an output image from the image sensing means.

27. A storage medium wherein the storage medium stores the control program of claim 22.

28. A control method of controlling a communication apparatus comprising image sensing means for sensing an object image, detection means for detecting reception of a signal from an external device, illumination means for illuminating an object, boosting means for supplying a power of said illumination means, and control means for controlling the image sensing means, the illumination means, and the boosting means, comprising:
the limiting step of causing the control means to limit boost operation of the boosting means when reception of the signal from the external device is detected by the detection means.

29. The method according to claim 28, wherein in the limiting step by the control means, the boost operation of the boosting means is stopped when reception of the signal from the external device is detected by the detection means.

30. The method according to claim 28, wherein in the limiting step by the control means, when reception of the signal from the external device is detected by the detection means, a driving current of the boosting means is made smaller than that while no signal is being received.

31. The method according to claim 28, wherein the communication apparatus further comprises a printer which prints an output image from the image sensing means.

32. A control program for controlling a communication apparatus comprising image sensing means for sensing an object image, detection means for detecting reception of a signal from an external device, illumination means for illuminating an object, boosting means for supplying a power of said illumination means, and control means for controlling the image sensing means, the illumination means, and the boosting means, wherein
the control means is caused to execute the limiting step of limiting boost operation of the boosting means when reception of the signal from the external device is detected by the detection means.

33. The program according to claim 32, wherein in the limiting step, the boost operation of the boosting means is stopped when reception of the signal from the external device is detected by the detection means.

34. The program according to claim 32, wherein in the limiting step, when reception of the signal from the external device is detected by the detection means, a driving current of the boosting means while the signal is being received is made smaller than that while no signal is being received.

35. The program according to claim 32, wherein the communication apparatus further comprises a printer which prints an output image from the image sensing means.

36. A storage medium wherein the storage medium stores the control program of claim 32.

37. A camera with a printer, comprising:
image sensing means for sensing an object image;
communication means for communicating a signal with an external device;
a printer which prints an output image from said image sensing means;
a DC power supply means having a booster circuit which receives a power supplied from a battery and supplies a driving DC power of said printer; and
limiting means for limiting boost operation in the booster circuit while communication is being executed by said communication means.

38. The camera according to claim 37, wherein
the camera further comprises a photoflash unit, and
said DC power supply means exclusively supplies a driving DC power of said photoflash unit and the driving DC power of said printer.

39. The camera according to claim 38, wherein
the camera comprises mode setting means for selectively setting a camera mode and a printer mode, and
said DC power supply means supplies the driving DC power of said photoflash unit using the booster circuit when the camera mode is set and supplies a printing or pumping DC power of said printer using the booster circuit when the printer mode is set.

40. The camera according to any one of claims 37 to 39, wherein said DC power supply means has a common boosting DC/DC conversion circuit which receives the power of the battery and outputs from separate terminals a DC voltage as the driving DC power of said photoflash unit and a DC voltage as the printing or pumping DC power of said printer.

41. The camera according to claim 37, wherein said limiting means stops the boost operation of the booster circuit while communication is being executed by said communication means.

42. The camera according to claim 37, wherein said limiting means makes a current of the booster circuit while communication is being executed by said communication means smaller than that while communication is not being executed.

43. The camera according to claim 37, wherein a timing while communication is being executed by said communication means includes a timing of call reception.

44. A control method of controlling a communication apparatus comprising image sensing means for sensing an object image, communication means for communicating a signal with an external device, print means for printing an output image from the image sensing means, boosting means for supplying a power of the print means, and control means for controlling the image sensing means, the communication means, the print means, and the boosting means, comprising:
the limiting step of causing the control means to limit boost operation of the boosting means while communication is being executed by the communication means.

45. The method according to claim 44, wherein in the limiting step by the control means, the boost operation of the boosting means is stopped while communication is being executed by the communication means.

46. The method according to claim 44, wherein in the limiting step by the control means, a driving current of the boosting means while communication is being executed by the communication means is made smaller than that while communication is not being executed.

47. The method according to claim 44, wherein a timing while communication is being executed by the communication means includes a timing of call reception.

48. The method according to claim 44, further comprising illumination means for illuminating an object.

49. A control program for controlling a communication apparatus comprising image sensing means for sensing an object image, communication means for communicating a signal with an external device, print means for printing an output image from the image sensing means, boosting means for supplying a power of the print means, and control means for controlling the image sensing means, the communication means, the print means, and the boosting means, wherein
the control means is caused to execute the limiting step of limiting boost operation of the boosting means while communication is being executed by the communication means.

50. The program according to claim 49, wherein in the limiting step, the boost operation of the boosting means is stopped while communication is being executed by the communication means.

51. The program according to claim 49, wherein in the limiting step, a driving current of the boosting means while communication is being executed by the communication means is made smaller than that while communication is not being executed.

52. The program according to claim 49, wherein a timing while communication is being executed by the communication means includes a timing of call reception.

53. The program according to claim 49, wherein the communication apparatus further comprises illumination means for illuminating an object.

54. A storage medium wherein the storage medium stores the control program of claim 49.
